(19) United States
(12) Patent Application Publication
(10) Pub. No.: US 2018/0357723 A1
(43) Pub. Date: Dec. 13, 2018

(54) SECURITIZATION OF INSURANCE CONTRACTS AND COST SHARING PLANS

(71) Applicant: Milan Kratka, Chicago, IL (US)

(72) Inventor: Milan Kratka, Chicago, IL (US)

(21) Appl. No.: 15/991,921

(22) Filed: May 29, 2018

Related U.S. Application Data
(60) Provisional application No. 62/511,707, filed on May 26, 2017.

(51) Int. Cl. G06Q 40/08

(52) U.S. Cl. CPC G06Q 40/08

(57) ABSTRACT

This invention creates commoditized insurance products and a physical marketplace that streamlines the process of insurance. It does it by:
1. Standardizing of insurance and cost-sharing plans that enables them to be listed on regulated exchange(s) and by utilizing central clearing-house with extended functionality that includes insurance administration. This minimizes the overall administration costs, minimizes actuarial insurance and other risks (risks are latent costs), and thus makes the process most efficient.
2. Creating supporting structures that enable exchange trading and central clearing of insurance products. These structures include expanded functionality of exchange's order-matching engine, added functionality of insurance administration to the central clearing-house, creating a system of the separate buyers, sellers, and backup pools allowing the proper handling of the payment mechanisms, and process of creating fair final settlement prices.
3. Defining mechanisms of operation for all parts of the process that make this solution the most cost effective.

### RELATED APPLICATIONS

This application claims priority to U.S. Provisional Patent Application No. 62/511,707, having a filing date of May 26, 2017. This application also claims priority to U.S. Provisional Patent Application No. 62/419,760, having a filing date of Nov. 9, 2016, both of which are also incorporated herein by reference in their entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The purpose of this invention is to create products and a mechanized system to streamline and maximize the efficiency of insurance and cost-sharing plans. The inventive system creates contracts for insurance, and an entire market for insurance and cost-sharing plans. Maximizing the efficiency encompasses minimizing costs involved, and minimizing actuarial, administrative, and cash flow risks.

The inspiration for this invention originated from the need to solve the problem of escalating costs and diminished access to affordable healthcare insurance in the United States. It is a goal of the claimed inventions to create a healthcare insurance market, and marketplace, such that health insurance would be affordable enough that every person in the country could be covered.

This invention creates efficient solutions not only for healthcare, but also for property, casualty, life, and other insurance and cost-sharing contracts.

In the United States, the richest country in the world, many people are without healthcare coverage. Healthcare insurance has become unaffordable for many people. For example, in 2017 in the state of Illinois the least expensive available healthcare insurance for a family of four cost about $2,000 a month. It came with about $3,500 deductible per person and about $14,000 deductible per family, and was available by only a handful of insurance providers. That represents a potential yearly cost of about $38,000, while the median income of a family was just about $60,000. Moreover, it provided very limited choice of doctors and healthcare facilities. With the cost of insurance premiums high, fewer people can afford and subscribe to it, which drives the actuarial risks higher, which drives the insurance premiums even higher in an unsustainable manner.

Meanwhile, healthcare insurance companies provide administration functions to companies for their employees and make profits. They make so much profit that it justifies their total market capitalization of over 2 trillion dollars (that is $2,000,000,000,000.00). It is possible because only a fraction of the premiums ends up in the doctors' and healthcare service providers' hands. In the current environment, healthcare insurance companies make profits if their insured get sick, and they also make profits if their insured are healthy. High healthcare costs also drive the cost of government services for poorer people via Medicaid and Medicate higher. There is a great need to minimize the costs and risks of healthcare services now more than ever.

One of the deficiencies of the current healthcare system is that insurance contracts allow people to choose from only a limited number of service providers. Moreover, people have no idea upfront of how much money is their doctor visit going to cost them, or whether it would be cheaper to get services like an X-ray done at different facilities. To make progress, it is also desirable that patients could choose and keep their own doctors, and doctors could win patients over without interference of anybody, including insurance companies.

This invention creates an insurance contract commodity and related marketplace, minimizes the costs and risks (risks are latent costs) of the insurance process, streamlines its administration, creates transparency of the costs, provides space for healthy competition, utilizes capital markets, leverages new technology, and results in eliminating inefficient middle-man companies in the process. If the costs and risks are minimized, then perhaps it would eventually be possible to have accessible affordable healthcare for everyone.

One aspect of the present claimed invention is standardization of insurance contracts (SIC's). In many industries significant progress has been achieved by standardization. Standardization simplifies the business. For example, standardization of video recording formats enabled viewing of videos made by large number of various companies on the same equipment. Standardization of computer data transmission protocols enabled creation of internet as we know it. Standardization of crude oil into futures contracts enabled commoditization and streamlining of crude oil commerce via global futures exchanges. Similarly, standardization of insurance and cost-sharing plans will enable streamlining and efficiency in businesses of insurance and cost-sharing. Business of insurance is typically much more regulated than business of cost-sharing. But the core purpose of both is very similar.

Besides standardization of contracts and technology for streamlining, transparency of costs is necessary for a fair price discovery process in competitive capital markets. The claimed invention creates products, structure, and mechanism in a solution designed to minimize costs and risks, and thus maximizes efficiency of insurance and cost-sharing business. It has also many desired positive side effect.

### BRIEF SUMMARY OF THE INVENTION

The purpose of this invention is to create a system for commoditized insurance products and marketplace, to streamline the process of insurance and cost-sharing plans, and to make it the most cost and risk efficient possible.

Standardization of insurance and cost-sharing products, streamlining the administration, minimizing the costs, minimizing the risks, utilizing efficient capital markets, providing transparency of the costs, and leveraging technology are the components of this solution.

The claimed inventions include:
1. Securitization of insurance contracts and cost-sharing plans, with
2. Structures supporting the securitization, and
3. Mechanisms of how it all works together.

This is not unlike an invention of a new engine, which would include description of the engine, supporting parts needed for this engine to work, as well as mechanism of how this engine and its supporting parts work together. Notes are included about related topics to better describe the invention and its advantages.

### BRIEF DESCRIPTION OF SEVERAL VIEWS OF THE DRAWINGS

FIG. 1 graphically illustrates the main components of the Securitized Insurance and Cost-Sharing Plans Structure of the present invention.

FIG. 2 graphically illustrates possible multiple exchanges listing securitized insurance products utilizing a central clearing-house.

FIG. 3 graphically shows that one central clearing-house may exist for the various types of insurance and cost-sharing plan products.

FIG. 4 illustrates the repetitiveness of these administration costs that can be saved by our solution with a single central clearing-house that does not need to make profit.

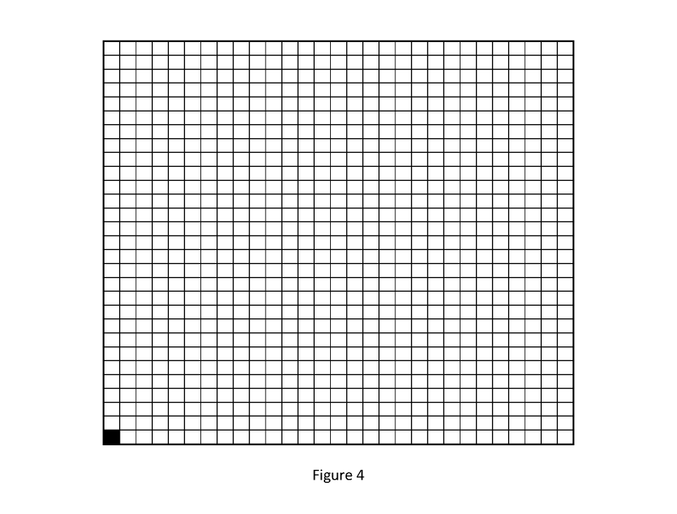

FIG. 5 represents the approximately 840 existing healthcare insurance companies insure a small fraction of the total population of the country, where the single small dark square represents an average population covered by one of these companies in comparison to all squares representing all insured people.

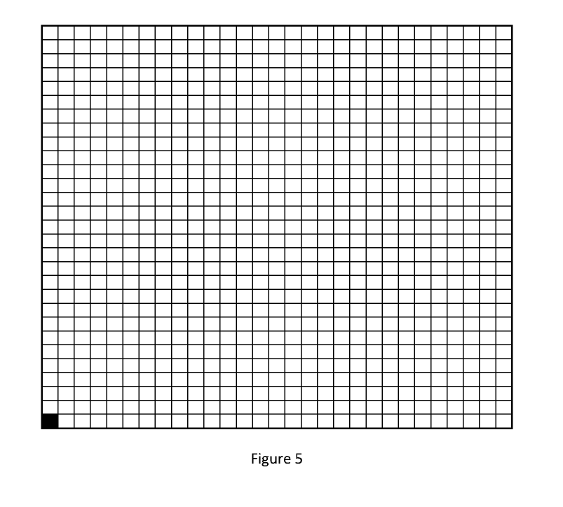

FIG. 6 graphically illustrates the mechanism of a life cycle of a securitized insurance or a cost-sharing contract.

FIG. 7 graphically illustrates represents the three pools that clearing house maintains.

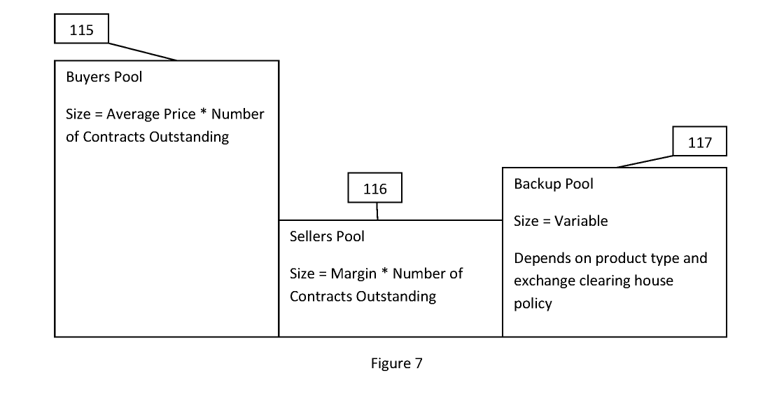

FIG. 8 graphically illustrates various Central Clearing-House Information Databases (DB's) of different types of information that the exchange and the clearing-house maintain to allow full and efficient functioning of mechanism of securitized insurance and cost-sharing plans.

FIG. 9 is a table explaining the exchange's Order-Matching Engine (OME) handling of funds at the time of a new transaction between a buyer and a seller, and funds movement into and/or from the Buyers Pool 115 and the Sellers Pool 116.

FIG. 10 is a matrix graphically illustrating the exchange's Order-Matching Engine (OME) handling of a contract's electronic ID token for the four scenarios created by two buy and two sell transaction types: buyer buying an additional contract or selling back a contract it already owns, and seller selling an additional contract or selling a contract it already owns.

FIG. 11 describes and graphically illustrates interactions of buyers of insurance products on the exchange with eventual owners of the insurance contracts via phone app or web browser or other electronic and non-electronic means; where, for instance, owners interact with the central clearing-house, and the central clearing house interacts with authorized service providers.

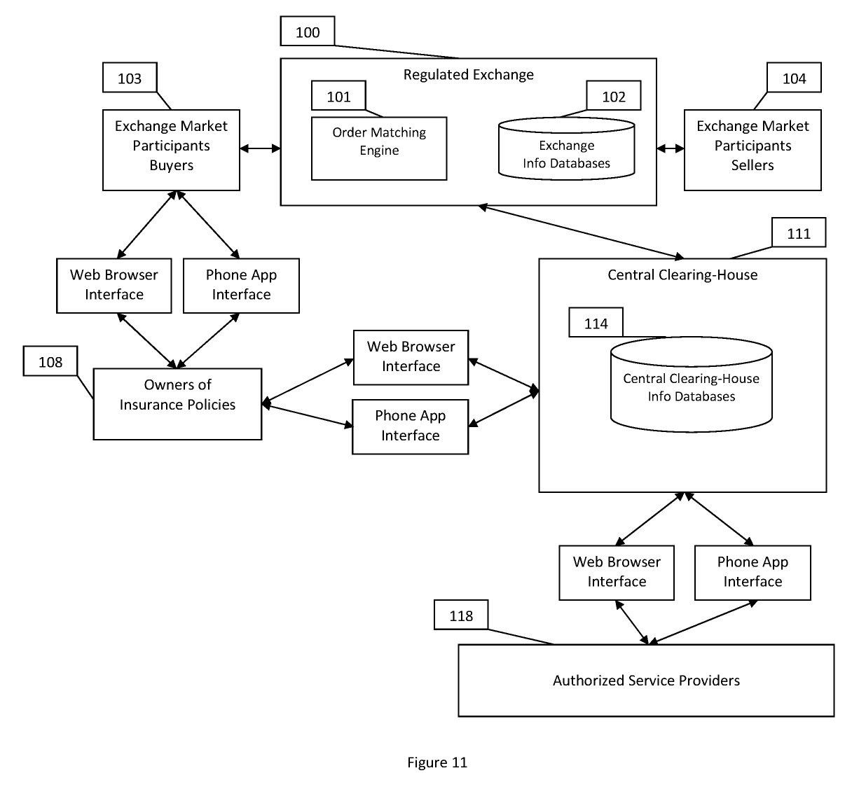

FIG. 12 describes Exchange Market Participants using computer servers connecting with the exchange's Order Matching Engine through an exchange interface for the purpose of buying and selling of standardized insurance contracts.

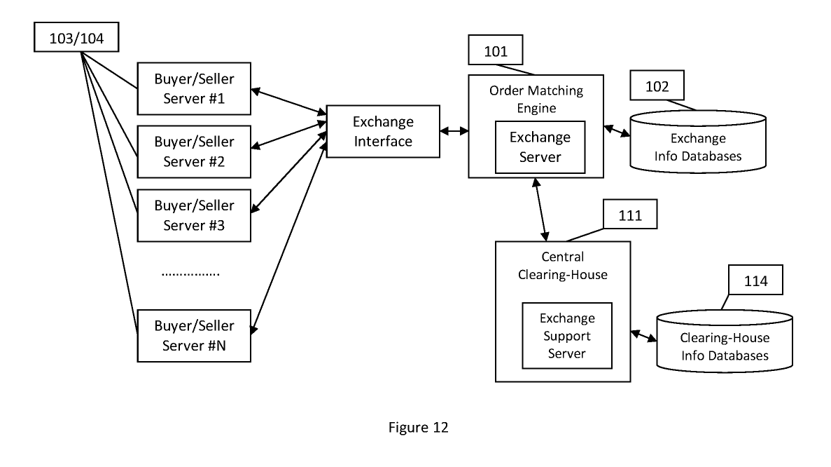

### DETAILED DESCRIPTION OF THE INVENTION

### Introduction

The purpose of this invention is to streamline the process of insurance. It is achieved via commoditization and securitization of insurance, creating physical supporting structures, and providing mechanism of it all working together. Simplifying the administration, minimizing the costs, minimizing the risks (risk is a latent cost), utilizing efficient capital markets, providing transparency of the costs, and leveraging technology make the claimed invention possible.

The purpose of insurance and cost-sharing plans is to protect from unexpected and severe financial or other loss by providing financial compensation in a case such a covered loss indeed occurs. It is essentially a risk management tool that allows a buyer of insurance policy to pay certain smaller amount of money to cover an uncertain unwanted event of a loss that could cost considerably more. Insurers collect money called premiums from many insured and pay out according to the policies when covered loss events happen.

As large cash flows happen in insurance business, there are significant costs and risks involved. Governments regulate the insurance business to protect insurance subscribers from fraudulent behavior of insurance companies and to protect the insurance companies from fraudulent behavior of insurance subscribers. But governments do not guarantee performance of the insurance companies. Insurance companies may go into default, out of business, and/or may not actually pay for all or some of the covered losses. In this invention, the securitized insurance and cost-sharing plans get listed on regulated exchanges (regulated for instance by SEC—the U.S. Securities and Exchange Commission, or by CFTC—the U.S. Commodities Futures Trading Commission) with maximum level of oversight and protection of buyers, sellers, and cash flows involved. The functions of an exchange and its clearing-house enable cost and risk-efficient capital markets, fair price discovery, maximum transparency, and accessible oversight. More than a billion transactions happen on SEC and CFTC regulated exchanges every day. It makes sense, and it would mean progress, to enable listing insurance contracts on exchanges as well.

Having access to a free or even an affordable, comprehensive or even a basic medical healthcare is currently still not one of the basic rights of the people of the United States. People are individually responsible for covering their medical costs. Some people can afford much more than others. The government does help the poor with its Medicaid and Medicare programs, but escalating of the costs makes it all more and more expensive for the government and thus for us all.

According to the Insurance Information Institute (www.iii.org), there are now about 6,000 insurance companies in the USA, of which about 840 provide healthcare insurance. Each of these companies must perform the same administrative functions as the rest, effectively doing the same work over and over.

Insurance companies carry much higher actuarial and other risks associated with administration of a small fraction of the whole pool of insurance subscribers. Currently, insurance companies actually further subdivide their population of insured into many smaller groups, making the actuarial risks even more significant.

Moreover, insurance companies do not do their business for free; they do it for profit. Current market capitalization of just the health care insurance companies is over two trillion dollars (that is $2,000,000,000,000.00). This astronomic number is justified by the profits they make, They administer payments and dictate prices and avoid transparency. They do not heal anyone, but they make profits when we are sick and they make profits when we are healthy. They are the middle-men in the healthcare business. They lobby the government and make large donations to politicians in order to make it difficult to find alternative solutions to problems of escalating costs of insurance for end users and associated escalating costs, risks, and profits of insurance companies.

Fortunately, progress cannot be stopped and advances in technology, existence of efficient capital markets, and inventions like this could provide alternative solutions to battle escalating costs and this difficult situation. It seems that the US government may be willing now more than ever to provide space for competitive solutions that would enable access to affordable insurance for all people. And possibly even help pave the road to it, which is very desirable. If we could slash the cost of healthcare by half, while actually providing better healthcare system, just the government itself would save about 8% of its budget. That would be huge, and it would push our country ahead by leaps.

The cost of insurance covers the costs of insurance administration, actuarial costs associated with average costs and frequency of covered events, risks associated with size of pool of insured, costs and risks of possible fraud, and profits insurance companies make. There are costs and risks associated with regulation and possible changes in regulation. There are also cash flow risks to the insured people as well as cash flow risks to the service providers who get paid from insurers according to the policies for fixing the covered loss events, for example, hospitals treating patients, or body shops for fixing cars after accidents.

In the case of healthcare insurance, the service providers (e.g., doctors) cannot compete for its customers (patients) freely. Most insurance policies do not allow total freedom to choose a doctor, and most doctors cannot compete for and choose their patients. In most cases, they cannot even set the prices for their own services. An X-ray could cost $800 in one and $50 in another place. There is very little transparency of the whole process. As a result, the costs are spiraling up in an unsustainable way.

The solution to these problems is claimed herein. Practicing the claimed inventions minimizes the costs, minimizes the risks (latent costs), and allows competition for the covered loss services, thus stabilizes the minimal costs of insurance. Our solution is beneficial to all parties involved, and thus it is sustainable. Moreover, there are many other positive side effects; some of them are described further down below.

1. Securitization of Insurance and Cost-Sharing Contracts

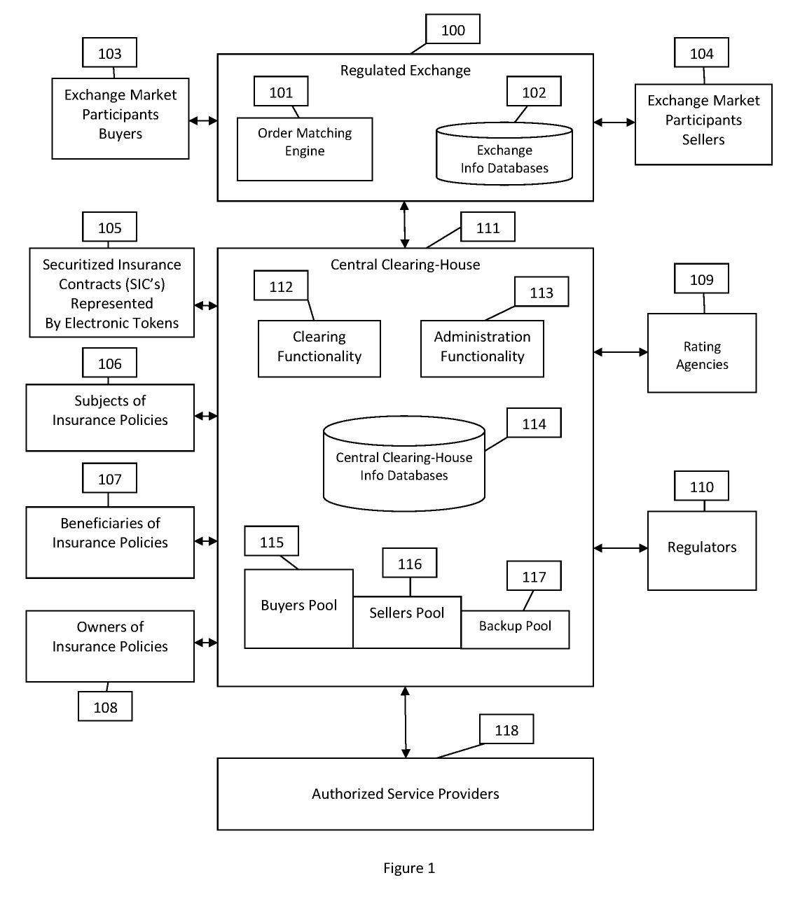

Many products have been standardized, securitized, and listed on exchanges. Those include equities, options, and commodities. This invention provides structures and mechanisms that allow insurance and cost-sharing products to be listed on exchanges and function as desired insurance vehicles. FIG. 1 describes the main components of the securitization of insurance and cost-sharing plans structure of this invention.

The mechanism can be described briefly as follows: Insurance and cost-sharing products (which we commonly refer to as SIC's) get standardized and subsequently listed on a regulated exchange 100 where they are traded. The regulated exchange 100 through the central clearing-house 111 guarantees all transactions and deliveries. The central clearing-house 111, besides its standard clearing functionality 112, undertakes new responsibility of central insurance administration 113. It maintains databases 114 with needed information of all market participants, eligible buyers 103, eligible sellers 104, outstanding insurance policies and their electronic token representations 105, subjects of insurance policies 106, beneficiaries of insurance policies 107, owners of insurance policies 108, and approved service providers 118. The central clearing-house 111 receives initial information through the process of registration, ratings, and approval, and it keeps continuously updating its databases 114. In a periodic cycle, typically monthly, the central clearing-house 111 pays out the covered loss claims according to individual policies using the collected money from the Buyers Pool 115, possibly funds from the Sellers Pool 116, and in a rare emergency, also from its own Backup Pool 117. The clearing-house then averages all the costs fairly over all listed products and produces their final settlement prices. Subsequently it credits or debits the sellers' accounts according to differences between their sale prices and the final settlement prices. The settlement prices do not affect buyers' account that paid for the bought contracts in full. The central clearing-house 111 then publishes statistical data on covered loss events, actual costs of covered loss services, and on anything useful to aid transparency of the costs structure. The published statistical data will f course preserve privacy of the market participants and anything required by the regulation. It will help actuarial scientists to price the insurance products fairly and competitively, it will help insurance owners 108 to choose service providers wisely, and it will also help the service industry to improve their business.

The first step of this invention is to standardize insurance contracts and cost-sharing plans so that they can be securitized and listed on a regulated exchange 100. We will refer to them commonly as SIC's. Standardization of insurance and cost-sharing contracts requires them to be simplified and generalized so they can be easily assigned and associated with any of eligible desired subjects of insurance 106 and serviced by any approved service providers 118. Simplification helps with streamlining as well as scaling up, but it can be a significant challenge.

Standardization involves choosing components and features of the contracts that would appeal to large number of potential buyers. It makes it possible to change ownership of a contract without a need of rewriting the contract itself. Standardization makes it possible to be listed and traded on a regulated exchange. One of many advantages of standardization is that it prevents hidden discrimination. For example, if an exchange-listed standardized insurance contract is not gender specific, then its cost cannot depend on the gender of the covered person, gender of the seller, or gender of the buyer.

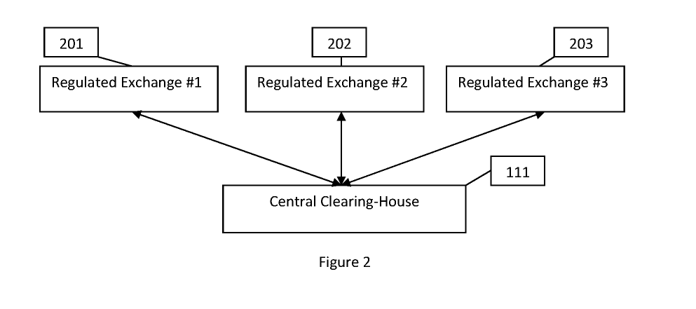

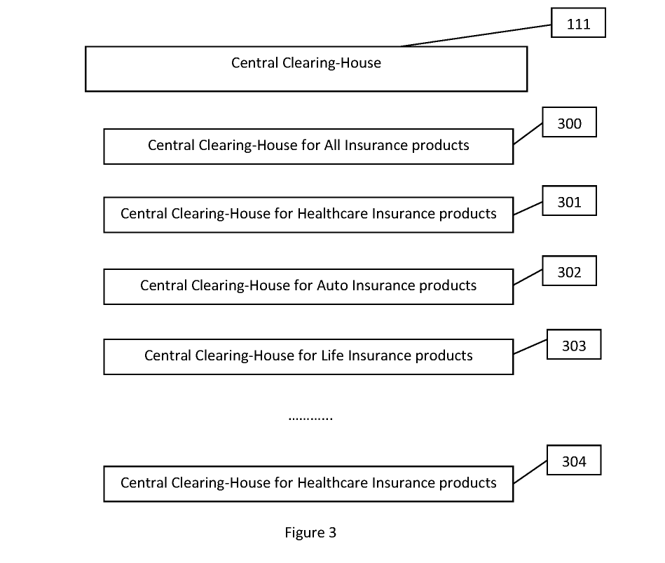

The purpose of having standardized insurance contracts (SIC's) is to enable them to be securitized and listed on regulated exchanges. There could be multiple exchanges that could list the same insurance product. But for the sake of minimizing administration costs, there should be just one central clearing-house shared by all exchanges that list insurance products. FIG. 2 illustrates this design. The central clearing-house 111 could ideally cover all insurance products, but it is possible to have central clearing-house for separate family/type/subsets of insurance products, like illustrated by FIG. 3. Besides cost saving with a single central administration, having just one central clearing-house has other advantages, including making it easier for the market oversight, regulatory, and fraud prevention functions.

A regulated exchange that lists insurance and cost sharing products needs to define rules for selecting eligible exchange market participants, namely buyers 103 and sellers 104 in a similar way that other exchanges do. Additional to existing regulation may need to be added to ensure orderly markets. The set of eligible buyers 103 does not have to be initially the same as the set of eligible sellers 104, as the financial obligations and exposure of the buyers differ from the financial obligations and exposure of the sellers. But ideally the two sets should be identical for more competitive markets.

Every issued standardized insurance or cost-sharing contract (SIC) gets assigned a unique electronic identification (ID) token 105 by the central clearing-house 111. Each outstanding electronic token will represent one instance of a securitized insurance contract. The central clearing-house 111 keeps track of these tokens and their association with subjects of insurance 106, beneficiaries 107, and owners 108 at all times. It will work seamlessly with additional design details on how these tokens are created, maintained, and decommissioned, and how do they get associated with eventual owners 108, beneficiaries 107, and/or subjects of the insurance policies 106.

Before the term of coverage of an SIC starts, its ID token needs to be associated with its eligible subjects of insurance policy, beneficiaries of the policy, and/or owners of the insurance policy. The association of the SIC's with eligible subjects and eligible beneficiaries of the insurance policies would happen by action of owners of the insurance contracts 108 through their interaction with the central clearing-house 111 via web browser or phone app interfaces, or by other alternative means. For example, if someone owns a car and buys a car insurance contract on an exchange for it, this insurance contract, through the means of its ID token, needs to be associated with this car and/or driver before the coverage term of the insurance policy takes effect. The vehicle identification number (VIN's) and/or driver license numbers may need to be associated with the contract's token. A Central clearing-house keeps track of all the associations. The exchange market participant 103 that buys an SIC on a regulated exchange 100 may keep its ownership, or transfer it; or sell it to a different eligible owner. Proper regulation would cover this procedure similarly to regulations that cover action of stock brokers.

An order-matching engine 101 of the regulated exchange 100 will need to create, transfer, or decommission electronic ID tokens 105 representing instances of SIC's at the time of transactions and coordinate information change with the central clearing-house 111 that needs it to track the electronic ID token data.

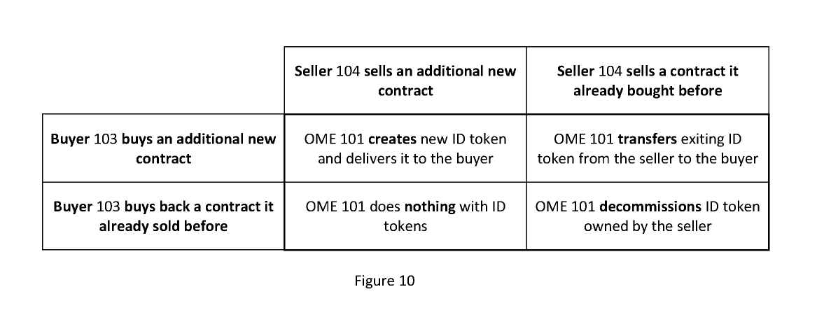

Current exchanges do not create tokens representing contracts while pairing buyers with sellers. The order-matching engine 101 of a regulated exchange 100 that wants to list insurance contracts represented by tokens 105 will have to add functionality that would properly deal with them and accept new types of orders that allow for creation and for deletion of insurance contract's electronic ID tokens. Namely, if an eligible seller 104 wants to sell an insurance contract on a regulated exchange 100 that the seller does not own, the order-matching engine 101 will create a new electronic ID token 105 and deliver it to the buyer the contract. If the seller 104 already has a contract that is going to sell, then the order-matching engine 101 uses the already existing contract's electronic ID token and transfers it to the buyer. On the other hand, if the buyer 103 wants to buy a new insurance contract, and the seller 104 does not already own it, the order-matching engines created a new contract ID token 105 and assigns it to the buyer. If the buyer 103 wants to buy back one insurance contract previously sold, then upon completion of the transaction the buyer will not get any ID token, and the buyer's short contract position will be reduced by one, the contract that the buyer just bought. FIG. 10 describes designed action of the order-matching engine 101 with respect to creating, transferring, and decommissioning of the ID tokens 105 at the time of a transaction depending on the order types of the matched buyer and seller. The exchange 100 and the central clearing-house 111 keep track of positions and ownership of all contracts, their electronic ID tokens, and all the relevant data.

The sellers 104 do not get assigned electronic ID tokens 105, nor are they associated with any tokens, unless they are buyers 103 as well. The electronic ID tokens remain property of the buyers. The reason is the very essence of function of an exchange: the exchange with its clearing-house is the counter-party to both the buyers and the sellers.

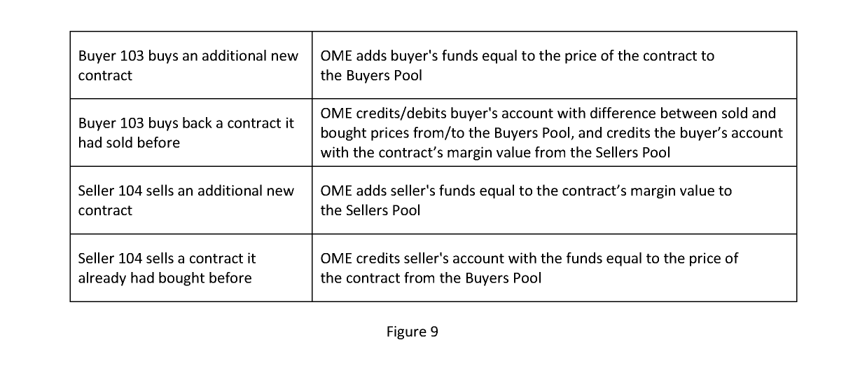

The buyer 103 pays full amount, plus prescribed transaction cost, for receiving the insurance or cost-sharing contract listed by the exchange. The exchange's central clearing-house 111 is responsible for delivering the services as described by the standardized insurance contracts (SIC's). The sellers 104 are responsible for providing risk capital in the form of margin funds that they need to maintain with the central clearing-house 111 from the time when they sell a contract until the time of the contract’ final settlement. The FIG. 9 explains designed action of the order-matching engine 101 and the central clearing house 111 with respect to moving funds between the buyer 103, the seller 104, and the central clearing-house pools, namely Buyers Pool 115, Sellers Pool 116, and Backup Pool 117.

The buyers benefit from the system by acquiring insurance products at competitive prices. The sellers benefit from the system by selling the insurance products at higher prices than their expected fair value and generating profit on their required margin capital and not having to worry about the insurance administration costs.

Having the system of tokens enables a buyer 103 to buy multiple contracts and then resell or assign them to multiple subscribers. This buyer could be actually a broker who buys insurance contracts on an exchange for multiple clients, not unlike stock brokers who buy stocks for their clients and charge clients small execution or management fee for their service. This could also be an online electronic commerce company that allows its clients to make purchase via their smart phone app or a web browser, similarly as it is practice in stock or other financial markets. Technological advances make the progressive ideas easier to implement.

Electronic exchanges often list thousands of contracts on their platforms, for example equity option exchanges like CBOE or ISE. Exchanges collaborate with so-called market making firms that are capable of providing continuous quotes of offer and bid prices, and can also quickly respond to requests for a quote. The very same is possible to do for standardized insurance contracts SIC's that may have many variations of their features and allow for a wide range of their parameters' values that enable potential insurance buyers to choose insurance product with the most desired features and parameter values that they are eligible for and that satisfy their needs. Rating agencies 109 may help the central clearing-house 111 identify eligibility of the potential insurance contracts owners 108, subjects of insurance 106, and beneficiaries of insurance 107. For example, some insurance buyers may be interesting in cost-sharing product with high deductible, some with low deductible. Some insurance buyers may be eligible for auto insurance for drivers over 25 years of age, some may not. Standardization and securitization of insurance and cost-sharing products do not restrict choices that insurance buyers would have.

The standardized insurance and cost-sharing products SIC's can be simply based and have some of the same features as existing insurance contracts, and some new features. The flexibility of exchange technologies allows having large variety of contracts, and therefore much wider set of parameters to choose from, than they are currently available on the market. For example, healthcare insurance contracts could offer wide range of out of pocket deductible amounts, per visit fees, percentage levels of coverage, and many other features.

Insurance contracts typically cover longer time periods, for example yearly or semiannually. The exchange listed contracts need to match exchange cycle with expires. A typical securitized standardized insurance product would have its term duration of coverage of one month, and a typical exchange cycle would be also one month. This is one of the keys for the central clearing-house’ management of the insurance administration including cash flows and risks. Monthly contracts are like building blocks that can be bundled into strips and cover longer terms. For example, a strip of six subsequent monthly auto insurance contracts would be covering half a year. The exchange could also list the strips outright as it is common in other exchange listed financial instruments. The central clearing-house may modify the timing of when the full amounts of the buyers funds are required for the further back months. For example, it may require buyers 103 to deposit margins for contracts with terms starting say two months ahead in the future and require buyers 103 to deposit full amount of their contracts value with terms starting less than two months ahead.

The purpose of some of the insurance contracts' features and parameters may be to motivate subscribers to behave more responsibly and also take a bigger portion of financial responsibility for the covered loss events. It may result in lowering upfront premium costs in exchange for higher deductibles in case a covered loss event happens.

On the other side, people may not by in a financial position to afford buying a low deductible insurance or cost-sharing contract even if it was available. This is currently an important issue with healthcare insurance.

The smaller number of people buying insurance makes it more risky for insurance underwriters, and so they increase the premiums to compensate for this actuarial diversification risk. That further decreases number of people who can afford buying insurance and results in unsustainable vicious circle of escalating premium costs, and/or lowering the value and quality of the covered services, and/or diminished covered benefits of the insurance contracts.

A healthcare insurance policy with parameter of covering 80% of the healthcare services costs will cost less than the policy that covers 95%. A life insurance policy for people smoking and drinking alcohol extensively would be likely more expensive than life insurance for people who don't. An auto insurance with $1,000 deductible would cost less than one having $250 deductible. An auto insurance policy with feature that enables insurance company to monitor the speed of the auto could cost 10% less than policy without it. There are many features like these that could lower the overall cost of the coverage. A small motivation can go a long way.

One of the features that we recommend for standardized insurance contract specifications, which will positively affect behavior of insurance subscribers, is to give the insurance owners 108 back a small percentage of unused premiums in form of say yearly or semi-annual cash or credit back. The central clearing-house 111 keeps track of premiums paid as well as covered expenses. If the premiums paid in a year are higher than the expense incurred, the clearing-house would credit the insurance owner's account by a small percentage (say 10% or 15%) of the difference between paid premiums and the actual costs of covered services. This feature can be easily implemented by the central clearing-house 111, capital markets would price it in before the contracts get sold, and the cash back feature would reward subscribers for taking better care of their insured property, lifestyle, and/or life. A small cash back motivation can go a long way in positively changing riskiness of people's behavior, which should contribute to further minimizing the cost of insurance.

An exchange could define standardized contracts that comply with regulatory requirements and laws of all states if possible, or it could define separate contracts designed specifically to comply with the regulations of each state. But since maximizing the size of insurance pool minimizes the insurance diversification risks, it is desirable to eventually converge to standardized unified regulated contracts that would satisfy regulations in all states. Hopefully the country's lawmakers and regulators would see the benefits of that and support it. It would make economical and practical common sense.

2. Structures Supporting the Securitization

The main structures supporting the securitization of insurance contracts and cost-sharing plans are regulated exchange(s) 100 and the central clearing-house 100, and the computers and servers and specialized content thereon. A regulated exchange is a place, a front office with servers, where sellers meet buyers and transactions commerce occurs. While a clearing-house is a place, a back office with servers, where the process of clearing all exchange transactions as well as processing of all administration tasks happen. Multiple exchanges could and should share one central clearing-house for the purpose of minimizing the costs and risks. For example, this is the case in the US equity options space where multiple options exchanges share the supporting services of one central clearing-house called Options Clearing Corporation, or shortly OCC.

Having only one shared central clearing-house 111 maximizes the size of the insurance pool, minimizes the costs and risks, and provides the best transparency needed for easiest regulatory oversight. Moreover, a clearing-house handling insurance, products also performs all needed administration functions. Having more than one clearing-house for the same insurance products would mean duplicate administration, smaller size insurance pools, and hence larger costs and risks. Therefore, having a central clearing-house 111 handling securitized insurance products, or at least insurance products of the same type (like healthcare insurance, or auto insurance), is needed to maximize the efficiency (cost and risks) of the system.

Any existing regulated exchange could handle the commerce of buying and selling of insurance or cost-sharing products if it could extend functionality of its order-matching engine with all supporting structures that would allow it to handle the processing of creation, reassignment, and decommissioning of tokens representing the insurance products as described above, A brand new exchange could also be created that would have all the needed functionality.

Any existing clearing-house could handle the clearing of insurance and cost-sharing products if it could extend its functionality to perform all insurance administration functionalities as needed. This could be achieved by either adding administration of an existing insurance company to the clearing-house together with the needed technology and support. Or by creating administration operations from scratch as extension of the existing clearing-house functionality.

There are thousands of insurance companies performing administrative functions in parallel with each other. It is a very inefficient and costly process. For example, each insurance company currently does its own advertising to compete against other insurance companies, acquiring and retaining customers, performing actuarial pricing, negotiating everything, handling both sides of claims, and much more. Besides covering the costs of administration and higher risks resulting from fragmentation, insurance companies exist to make profit. One central clearing-house would not necessarily need to make profit, just cover its costs. An interest of all insurance market participants is to minimize the costs and the risks (risks are latent costs), and therefore having just one central clearing-house 111.

One of the supporting functions of the exchange 100 and the central clearing-house 111 is information and data management. That includes management of the eligible market participants, including buyers 103, sellers 104, subjects of insurance contracts 106; and eligible authorized service providers 118. The eligible buyers and sellers of insurance products on the exchange can be restricted to registered licensed entities to ensure orderly markets, just like on other regulated exchanges. Examples of subjects of insurance contracts 106 may be cars and drivers for auto insurance or auto cost-sharing products, and people to be covered with healthcare insurance or cost-sharing products. The central clearing-house 111 needs to maintain database of authorized service providers 118 for insurance products that need it, including auto insurance or healthcare insurance. The service providers need to maintain certain required standards in order to guarantee quality service that the central clearing-house 111 needs to secure to the insurance subscribers.

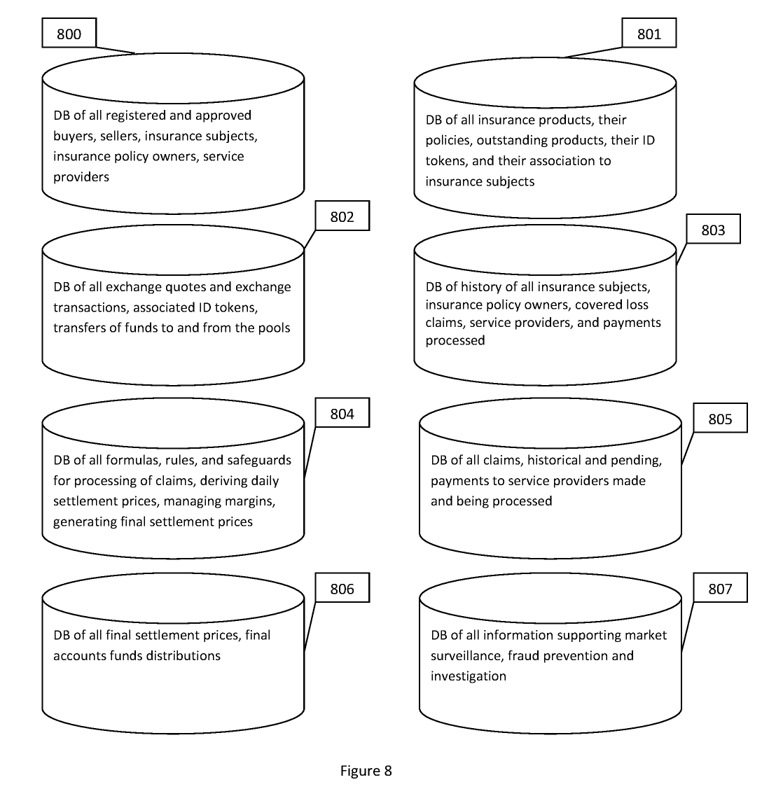

FIG. 8 lists different types of information databases 114 that the central clearing-house 111 needs to maintain continuously for the proper market functions. The regulated exchange 100 needs to continuously maintain its own databases 102 containing information that allows it to maintain orderly markets. In general, it is different set of information from what clearing-house maintains. In practice the exchange 100 would continuously interact with the central clearing-house 111 to maintain and update its database information.

The central clearing-house 111 needs to maintain and manage funds contained in insurance pools in order to fulfill the deliveries of the payments on the insurance claim obligations in a monthly cycle. Namely, the Buyers Pool 115 containing funds from contracts buyers 103. It should have more than enough funds to cover all costs of insurance, including covered loss service fees (the sellers would not intend to sell insurance and cost-sharing contracts priced below expected final settlement prices). And the Sellers Pool 116 containing margins funds from contracts sellers. This pool is essentially a risk management pool that allows the central clearing-house 111 to cover the service costs and associated expenses in a rare case that the Buyers Pool 115 does not have enough funds to do so. The margins for the sellers 104 are set by the central clearing house 111 and can be continuously adjusted to satisfy the perceived mispricing risks. And finally, the Backup Pool 117 that the central clearing house maintains continuously for emergency purposes. It would be continuously replenished on monthly basis by pre-defined fees that are either part of each exchange transaction fees and/or part of the listed insurance contracts' values.

Exchanges produce settlement prices at the end of every trading day for all their listed products. That is important for maintaining orderly markets and proper margins. Moreover, a regulated exchange 100 listing insurance and cost-sharing products and its central clearing-house 111 also needs to generate the final settlement prices typically on monthly basis by averaging all costs in the same family/type of insurance products accumulated until the end of insurance period and allocating them across all products fairly. By the same family/type we mean the insurance products sharing the same pools, for example all auto insurance products, or all healthcare insurance products. This task is a little more complex than creating settlement prices of other exchange traded products and involves using specific mathematical formulas and statistical data processing to average the costs fairly across the products with various features and parameters and tailoring the process of final settlement price creation to each particular type of insurance products. The formulas and methods can be updated by the clearing house on as needed basis but needs to be disclosed to market participants beforehand so they can better price individual contracts based on their expected relative values. This is one of the key structures needed in place for the market to work fairly.

One of the key supporting structures of this invention is periodical publishing of statistical data related to the insurance products by the central clearing-house 111. It supports general transparency of relevant specific statistical information needed for more precise actuarial pricing of the insurance and cost-sharing products. It also supports general development of the businesses that provide service of covered loss claims. Moreover, published statistical data support better oversight and regulatory functions all good for positive future improvements. For example, in the auto insurance area, the central clearing-house may publish monthly statistics data on the insured automobiles, including the number and type of claims, average and standard deviations of the costs sorted by regions/counties. In the healthcare insurance area, it may publish average and standard deviation of the costs of medical procedures and services, their frequency, and also sort the data by regions/counties. In the life insurance area, it may publish mortality rates for every age group in the last month. Publishing of statistical data will produce positive feedback that has positive consequences on economy and people we perhaps can only dream of now. For example, people will be able to make better decisions about which medical facility or car repair service they would want to visit. When insurance subscribers have a financial commitment, it makes them balance the out-of-pocket and deductible costs with perceived quality of the service they will receive. Service providers will have better idea how to compare to their competition, how to grow their business, and how to provide more competitive services and attract potential new customers or patients.

Since insurance subscribers are interested in long-term contracts, and the exchange 100 would list insurance and cost-sharing contracts SIC's in the short-term monthly cycle, the long-term contracts could be listed outright or be available through the so called strips, just like they are available in other financial products listed on regulated exchanges. A strip would be just a bundle of consecutive monthly contracts. A settlement price of a strip would be the sum of the settlement prices of its monthly components.

Insurance contracts could be purchased directly or through purchasing agents, just like other securities, such as stocks can be purchased through the brokers. The purchaser/buyer 103 could finance the long term contracts as strips and perhaps charge its customers a fee for the service of added value. The exchange could also provide electronic facilities that would allow buyers to lock in the prices, pay cash for the front/nearby month contracts, and post margins for the back month contracts.

Besides strips, other derivative instruments will be very useful for making the securitized insurance markets complete. These would include futures, spreads, strips, trade at settlement contracts, and options.

3. Mechanisms of how it all Works Together

After describing essential components of insurance securitization, we outline the mechanism that makes these new insurance products work practically.

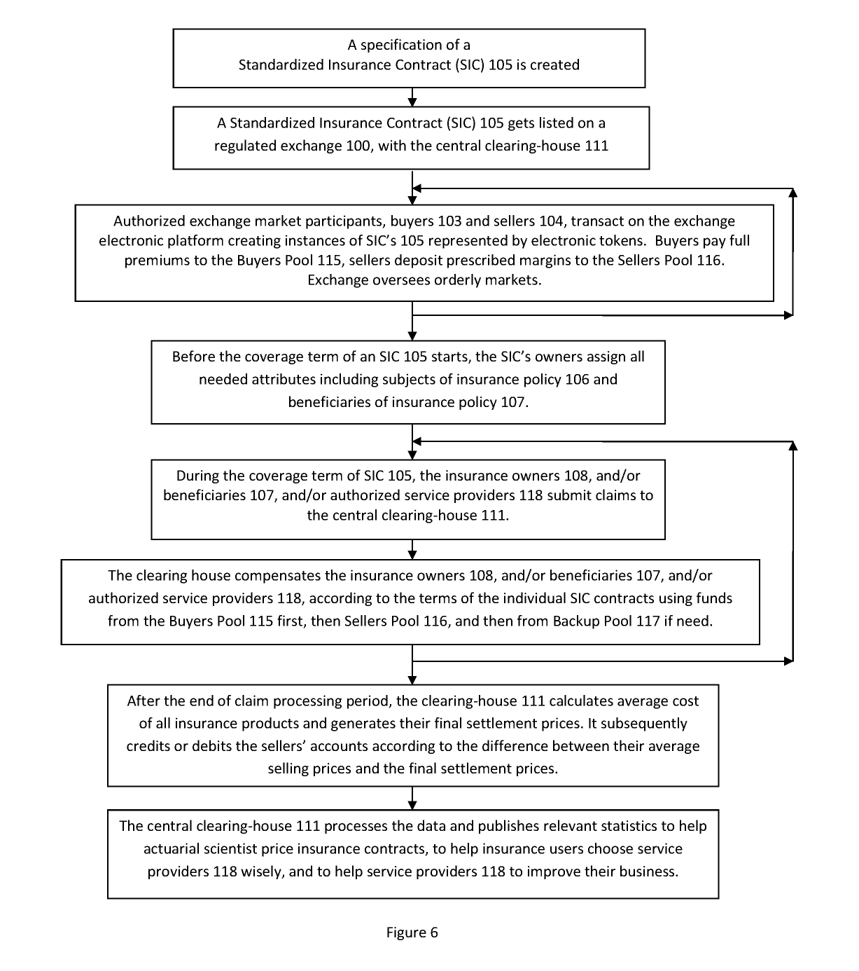

The mechanism can be described briefly as follows (see also FIG. 6 for flow chart describing this mechanism): Insurance products get standardized and subsequently listed on a regulated exchange 100 where they are traded between buyers 103 and sellers 104. The exchange 100 through the central clearing-house 111 guarantees all transactions and deliveries and undertakes new responsibilities of central insurance administration. The central clearing-house 111 maintains databases 114 with needed information of all market participants, eligible buyers 103, eligible sellers 104, outstanding insurance policies 105, subjects of insurance policies 106, beneficiaries of insurance policies 107, owners of insurance policies 108, and authorized service providers 118. The central clearing-house 111 receives initial information through the process of registration, ratings, and approval, and it keeps continuously updating it. In a periodic cycle, typically monthly, it pays out the covered loss claims according to individual policies using the collected money from the Buyers Pool 115, possibly funds from the Sellers Pool 116, and in a rare emergency, also from its own Backup Pool 117. The central clearing-house 111 then averages all the costs fairly over all listed products and produces their final settlement prices. Subsequently, it credits or debits the sellers' accounts according to differences between their sale prices and the final settlement prices. The central clearing-house 111 then publishes statistical data on covered loss events, actual covered loss services, and on anything useful to aid transparency of the cost structure. It will help actuarial scientists to price the insurance products as fairly and competitively, help insurance users to choose service providers wisely, and the service industry to improve their business.

Insurance products get standardized and subsequently listed on a regulated exchange where they are traded. Standardization of insurance products and cost-sharing plans SIC's is the first part of the whole process. It can be done by an existing or a new regulated exchange that would want to list insurance or cost-sharing products. If the product is regulated, then the choices of its features need to fall within the required norms of regulation. Progress and innovation cannot be stopped, so eventually efficiency will help guide both the features of the products as well as their regulation.

Contracts with monthly term duration will enable the regulated exchange 100 to work in a monthly settlement cycle. These monthly contracts will serve as building blocks for insurance contracts with longer duration via bundling together in strips.

The exchange 100 through the central clearing-house 111 guarantees all transactions and deliveries, and the central clearing-house 111 undertakes new responsibility of central insurance administration. Exchanges already perform functions of a central market place supporting commerce of buying and selling listed contracts. The new functionality of the central clearing-house 111 is to perform set of functions of a typical existing insurance administration. The central clearing-house will need to handle claims and pay the registered authorized service providers 118 according to the individual policies. The amount it pays will depend on the terms of the insurance products and may depend on the history of the payments already made in a case that the particular policy has a look back option in it. For example, if there is a yearly out-of-pocket healthcare deductible of $1,000, the clearing-house needs to look back to the start of the yearly policy period. If the insurance contracts pay back to the insurance owner 10% of the yearly balance between paid premiums and cost of covered loss services covered, the clearing-house would evaluate how much money to pay back to the covered insurance owner. All information needed for this shall be readily electronically available internally at the central clearing-house's databases 114 as it maintains all records on all market participants, buyers 103, eligible sellers 104, policy owners 108, policy subjects 106, and authorized service providers 118.

The central clearing-house 111 will provide electronic means for the registered authorized service providers 118 and for the insurance owners 108 to submit all supporting documents and information that is needed to process covered claims. The goal of having just one single platform allowing the central clearing-house 111 to electronically communicate with all market participants will further drive the costs of insurance business down. This platform could have its front-end application implemented via secured internet browser and/or phone app technologies to maximize its accessibility and scalability. The central clearing-house 111 can build its supporting technology itself or chose technology from outside service providers in a competitive way.

Maximizing automation of electronic processing portion of claims handling shall further drive the cost and time of processing down. Improvements in new technologies and applied Artificial Intelligence fields should contribute to success of this progressive approach. It will also help with important functions of surveillance, fraud prevention, and fraud protection.

The central clearing-house 111 will pay authorized service providers 118, and/or policy owners 108, and/or policy beneficiaries 107 for the covered loss claims according to policies of their insurance contracts. The limits on how much can authorized service providers 118 get compensated for an approved covered service may come from a few places. One of the limits may come from a percentage that covered person needs to cover out of pocket. Reasonable limits could be embedded inside an insurance or cost-sharing contract in an explicit or implicit form. An explicit form would have a dollar number; an implicit form may have a formula that depends on a localized statistics. For example, the limit may be 25% above the local (county or region wise) average cost for the particular service as maintained by the central clearing-house 111.

The funds for payments to authorized service providers 118, and/or to insurance policy beneficiaries 107, and/or to insurance policy owners 108 will come first from the collected funds in the Buyers Pool 115 in a timely manner. If the Buyers Pool 115, which is composed of the funds paid by insurance contracts buyers 103, gets depleted, the central clearing-house 111 would use the Sellers Pool 104, which is composed of the margin funds deposited by insurance contract sellers 104, to cover the difference. The exchange sets margins for the sellers 104 high enough to cover the perceived pricing risks and can increase or decrease them on as needed basis. In an emergency case, the central clearing-house 111 could use its own Backup Pool 117 to cover the remaining difference. This Backup Pool 117 could be composed from funds allocated to it as a predefined portion of the exchange transaction fees and/or predefined insurance contract values, fixed or proportional, and its size or its existence could dependent on particular type of insurance or cost-sharing products. If the central clearing-house 111 would be guaranteed by the government, or another entity, then its performance could be further improved. This supporting function of the government would be additional and desirable for creating peace of mind of insurance owners and insurance beneficiaries, especially for the healthcare products.

Subsequently, after all claims are processed and payments made, the central clearing-house 111 averages all costs fairly over all listed products sharing the same pools and produces their final settlement prices. This is a new process for a clearing-house to perform. Transparency of the methodology and formulas chosen for producing settlement prices via averaging the costs is essential for fair pricing, with some mathematics and statistics needed.

As soon as final settlement prices are produced, the central clearing-house credits or debits the sellers' accounts with differences between their sale prices and the final settlement prices.

Subsequently, the clearing-house publishes statistical data on covered loss events, covered loss services, and on anything useful to aid transparency of the cost structure of the insurance process. It will help actuarial scientists to price the insurance products as fairly and competitively, help insurance users to choose service providers wisely, and help the service providing companies to improve their businesses.

One of the benefits of securitized insurance is that it will enable financial markets to benefit from the transparency of the insurance process. It will allow for competitive pricing and better risk management process. The future costs of insurance could be estimated and managed through mechanism of active futures and options markets. It will enable better hedging of the costs for consumers, financial institutions, as well as government agencies. For example, it would also allow for much simpler and much more cost efficient administration of government programs like Medicare and Medicaid, further lowering the overall costs of healthcare.

Securitization of the insurance products and cost-sharing plans is designed not only to significantly reduce costs of the insurance for the insurance buyers, but also to significantly reduce costs to insurance sellers by eliminating most of the overhead administration costs through centralized administration performed by the central clearing-house. It is designed to utilize efficient capital markets for providing risk capital and the transparency allows for competitive fair price discovery. Securitization with its standardization allows insurance buyers to choose from any available approved covered loss service providers. It also allows the service providers to compete for customers to choose them. These are some of the most desired features that would mean significant improvement in the healthcare insurance area where currently people cannot freely choose and keep healthcare service providers, and healthcare service providers cannot freely compete for their patients.

One of the positive effects of securitization of insurance is that it removes restrictions on whom you can buy the insurance from or how long you can have it. If competitively priced insurance contracts are available on a regulated exchange, it can be bought there no matter where you may currently work.

Another positive and sometimes overseen side effect of the securitization of insurance and cost-sharing products is elimination of potential subjective discrimination of who the buyers are or who the sellers are, for example gender discrimination. All buy and sell transactions done on an exchange platform are done anonymously with the clearing house being the counterparty and the trade guarantor for both the buyers and the sellers.

The central clearing with monthly settlement cycles means scheduled and timely payments to authorized service providers 118, and/or insurance beneficiaries 107, and/or insurance owners 108, which further reduces risks of the cash flows, and thus lowers the costs and risks of their businesses. Central clearing also means maximizing insurance pool, which statistically reduces diversification risks. Securitization resulting in lower costs of insurance will also lower costs of insurance for businesses and even for the government.

Additionally, regulated exchanges could list derivatives of actual listed insurance contracts, like futures, strips, spreads, trade at settlement contracts, indexes, and options, with either financial or physical settlements. These derivatives could provide additional tools for hedging of the future insurance costs.

This solution also provides a path for overcoming some of the current obstacles for progress in the insurance business. Regulation adapts to the progressive ideas, new technologies, and new solutions as they become reality. It is a process of streamlining and progress that this invention wants to contribute to.

What is claimed is:

1. A method for securitizing an insurance product on a regulated exchange including:
a. providing standardized insurance products to be listed on a regulated exchange;
b. providing an exchange platform comprising dedicated servers storing standardized insurance products;
c. listing the products on a regulated exchange via an electronic ID token;
d. defining eligible exchange market participants as buyers and sellers of insurance contracts on the exchange;
e. utilizing a matching engine to perform creation, transfer, and decommissioning of electronic ID tokens;
f. assigning outstanding insurance contracts to eventual owners, and assigning subjects of insurance and beneficiaries of insurance to the outstanding insurance contracts;
g. creating, funding, and managing a Buyers Pool, a Sellers Pool, and a Backup Pool comprising a central clearing-house;
h. utilizing the Buyers Pool, the Sellers Pool, and the Backup Pool in paying for the covered losses to insurance beneficiaries, owners, and/or authorized service providers; and
i. generating final settlement prices of the standard insurance products using a substantially averaged cost of all products of the substantially same type and duration.

2. A computer network and software apparatus comprising a standardized insurance marketplace comprising:
a. at least one server listing standardized insurance products on a regulated exchange;
b. the server adapted for allowing: facilitating transactions between buyers and sellers of the insurance products on a regulated exchange;
c. the server adapted for allowing: creating, transferring, and decommissioning of electronic ID tokens representing instances of the insurance products;
d. the server adapted for allowing: transferring and managing ownership of the insurance and cost-sharing products between eligible exchange buyers and eventual insurance owners with a central clearing-house comprising databases including identifying information for all buyers, sellers and products associated with ID tokens;
e. the server adapted for allowing: managing information in the databases of a central clearing-house;
f. the server adapted for allowing: reporting claims by insurance contract owners and/or beneficiaries, and/or authorized service providers;
g. at least one computer processor communicatively connected with the central clearing-house adapted for processing the reported claims and managing process of making payments for covered claims according to the individual insurance policies;
h. the server adapted for allowing: generating final settlement prices by substantially averaging costs of insurance and allocating the costs evenly amongst substantially all insurance products of substantially the same type and duration; and
i. the server adapted for allowing: periodic publishing of statistical data related to the costs of the insurance products.
